(19) United States
(12) Patent Application Publication
(10) Pub. No.: US 2017/0077777 A1
(43) Pub. Date: Mar. 16, 2017

(54) TOTALLY ENCLOSED MOTOR

(71) Applicant: Hyundai Motor Company, Seoul (KR)

(72) Inventors: Dongjin Nam, Hwaseong (KR); Myungwon Lee, Seongnam (KR); Yu Hyun Sung, Seoul (KR); Jeong Min Shin, Suwon (KR)

(21) Appl. No.: 14/978,955

(22) Filed: Dec. 22, 2015

(30) Foreign Application Priority Data
Sep. 11, 2015 (KR) 10-2015-0129219

(51) Int. Cl. H02K 5/04; H02K 5/22; H02K 3/28; H02K 11/00; H02K 1/27

(52) U.S. Cl. CPC H02K 5/04; H02K 11/0015; H02K 1/27; H02K 3/28; H02K 5/225

(57) ABSTRACT

A totally enclosed motor is provided that includes a housing which forms a motor space for the motor and a motor unit that has a rotor, a stator, and a rotor shaft. Additionally, a position sensor unit is configured to measure an angular position of the rotor. The motor space is air-tightly split to form a first space that encloses the motor unit and a second space that encloses the position sensor unit.

### CROSS-REFERENCE TO RELATED APPLICATION

The present application claims priority to Korean Patent Application Number 10-2015-0129219 filed on Sep. 11, 2015, the entire contents of which application are incorporated for all purposes herein by this reference.

### BACKGROUND

(a) Field of the Invention

The present invention relates to a totally enclosed motor, and more particularly, to a totally enclosed motor that prevents condensation from occurring in the motor by a simplified structure change of the motor.

(b) Description of Related Art

Generally, a hybrid vehicle or an electric vehicle generate a driving torque using an electric motor (hereinafter, referred to as “motor”) which generates a torque with electric energy. For example, the hybrid vehicle is driven in an electric vehicle (EV) mode, which is an electric vehicle mode, using power of the motor or in a hybrid electric vehicle (HEV) mode using both of the torques of an engine and the motor as power.

Further, the general electric vehicle is driven using the torque of the motor as a power source. Accordingly, the motor used as the power source of the hybrid vehicle includes a stator and a rotor, and the stator is mounted in a motor housing and the rotor is generally disposed inside the stator at a predetermined gap. In particular, the stator may include a stator core made of an electrical steel sheet and a coil wound around the stator core, in which a substantial amount of heat is generated in response to an alternating current (AC) current applied to the coil and an eddy current is generated in the stator core by a counter electromotive voltage due to the AC current and a change in magnetic flux generated by a rotating magnet.

Therefore, the motor equipped in the hybrid vehicle has a larger amount of heat generated in the stator core due to the current. Further, the rotor generally includes a permanent magnet. However, depending on the type of motor, the stator may also include the permanent magnet and the coil may also be wound around the rotor.

Generally, main parts which generate heat inside a motor housing upon the driving of the motor are the coil and the permanent magnet. Meanwhile, a totally enclosed motor is a motor in which the motor housing completely encloses the motor to prevent air around the motor from being introduced and circulated into the motor. Therefore, the totally enclosed motor may prevent the inside of the motor housing from being polluted due to external foreign matters but may not be cooled by the introduction and circulation of external air, thus requiring a separate heat exchanger for cooling.

In particular, in the existing totally enclosed motor, moisture in internal air thereof may be condensed and thus the condensation occurs on surfaces of internal parts or an inner surface of the motor housing. As a result, high voltage power lines, sensor signal lines, etc., inside the motor may be short circuited, electric wires and connectors may be corroded, etc., and thus, the failure occurrence and the performance degradation of the motor may occur. These affect the reduction in stability and durability of the vehicle, and therefore should be necessarily improved.

The above information disclosed in this section is merely for enhancement of understanding of the background of the invention and therefore it may contain information that does not form the prior art that is already known in this country to a person of ordinary skill in the art.

### SUMMARY

The present invention provides a totally (e.g., completely) enclosed motor having an advantage of preventing condensation which may cause a failure and a performance degradation from occurring at internal parts and around the internal parts by a simplified structure change of the motor without increasing costs.

An exemplary embodiment of the present invention provides a totally enclosed motor that may include a housing that forms a motor space for the motor, a motor unit including a rotor, a stator, and a rotor shaft, and a position sensor unit configured to measure an angular position of the rotor, wherein the motor space may be air-tightly split to form a first space that encloses the motor unit and a second space that encloses the position sensor unit.

The totally enclosed motor may further include an electrical harness configured to supply electricity to the motor unit, wherein the electrical harness may be disposed inside the first space. The totally enclosed motor may further include an electronic component in the second space. The electrical harness may include a 3-phase bus bar, and the motor space may be air-tightly split by a bulkhead formed between the bus bar and the position sensor unit. Additionally, a ventilation hole may be omitted at the housing for the second space. Additionally, an air permeable material may be omitted at the housing for the second space and an active heating device may be omitted in the second space.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram schematically illustrating an internal space of a known totally enclosed motor before and after the known totally enclosed motor is driven according to the related art;

FIG. 2 is a saturated vapor pressure line diagram illustrating a state change in internal air before and after a totally enclosed motor is driven according to the related art;

FIG. 3 is a saturated vapor pressure line diagram illustrating a case in which condensation is prevented by suppressing an internal pressure from increasing according to the related art;

FIG. 4 is a saturated vapor pressure line diagram illustrating a case in which condensation is prevented by increasing a contact surface temperature according to the related art;

FIG. 5 is a diagram schematically illustrating the internal space before the known totally enclosed motor is driven according to the related art;

FIG. 6 is a diagram schematically illustrating an internal space after the existing totally enclosed motor is driven according to the related art;

FIG. 7 is a diagram schematically illustrating an internal space before a totally enclosed motor according to an exemplary embodiment of the present invention is driven;

FIG. 8 is a diagram schematically illustrating the internal space after the totally enclosed motor according to the exemplary embodiment of the present invention is driven; and

FIG. 9 is a cross-sectional view of the totally enclosed motor according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail so that those skilled in the art may easily perform the exemplary embodiments of the present invention with reference to the accompanying drawings.

The exemplary embodiment is one exemplary embodiment of the present invention and may be implemented in various forms by those skilled in the art, and therefore the scope of the present invention is not limited to the exemplary embodiments to be described below. Throughout the present specification, unless explicitly described to the contrary, “comprising” any components will be understood to imply the inclusion of other elements rather than the exclusion of any other elements. Further, names of components do not limit functions of the corresponding components.

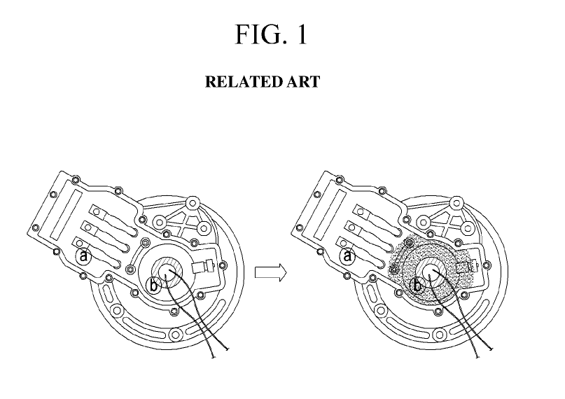

FIG. 1 is a diagram schematically illustrating an internal space after and before the existing totally enclosed motor is driven according to the related art. A left figure of FIG. 1 is an inside appearance before the totally enclosed motor is driven and a right figure of FIG. 1 is an inside appearance after the totally enclosed motor is driven. Referring to FIG. 1, region \textcircled{a} includes a 3-phase bus bar and terminal block of the motor and region \textcircled{b} includes a position sensor and a signal line connector of the position sensor. As illustrated in the right figure, after the motor is driven, moisture in internal air may be condensed in region \textcircled{b} and thus condensation may occur.

When a temperature of a stator and a rotor increases due to the driving of the motor, temperature in air inside a motor housing increases due to a convective heat transfer and the internal air is not ventilated (e.g., discharged) to the outside due to the totally enclosed structure (e.g., completely enclosed structure) to increase both of a temperature and a pressure of the internal air. The internal air having the increased temperature and pressure has a dew point temperature higher than an initial state and the internal air is cooled to a temperature below the dew point and thus the condensation occurs on surfaces of parts of region \textcircled{b} in which temperature is relatively low.

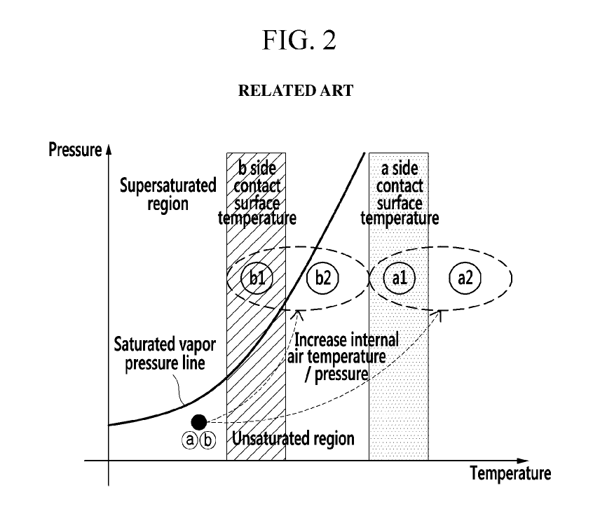

FIG. 2 is a saturated vapor pressure line diagram illustrating a state change in internal air before and after the totally enclosed motor is driven according to the related art. As illustrated in FIG. 2, the air of region \textcircled{b} of FIG. 1 is positioned in an unsaturated region before the motor is driven and then is changed to a state of b1-b2 by increasing both the temperature and the pressure by the driving of the motor. Further, the air in region \textcircled{a} of FIG. 1 may be changed to a state of a1-a2. Additionally, surface temperatures of parts in the region \textcircled{a} and the region \textcircled{b} are different from each other since the 3-phase bus bar disposed in the region \textcircled{a} is supplied with a current upon the driving of the motor and therefore the temperature increases, while a position sensor and a signal line connector of the position sensor disposed in the region \textcircled{b} exhibits a minimal temperature change. Therefore, the surface temperatures of the motor housing portion and the 3-phase bus bar in the region \textcircled{a} may be greater than those of the motor housing portion and the position sensor in the region \textcircled{b}, as illustrated in FIG. 2.

In other words, a contact surface temperature between the internal air and the parts in the region \textcircled{a} may be greater than a contact surface temperature of the internal air and the parts in the region \textcircled{b}. As a result, the internal air which is in a b1 state contacts the parts having temperature less than the dew point and thus is in a supersaturated state, and the condensation may occur on the contact surface. On the other hand, the internal air in b2, a1, and a2 states having a relatively higher temperature in the same pressure state is in the unsaturated state, and therefore the condensation may not occur.

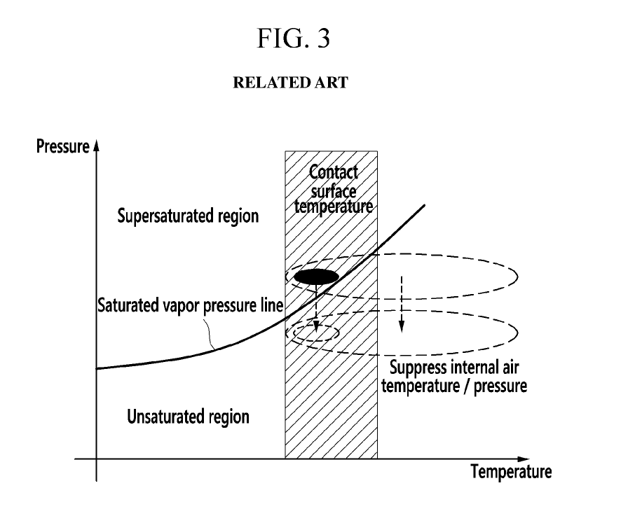

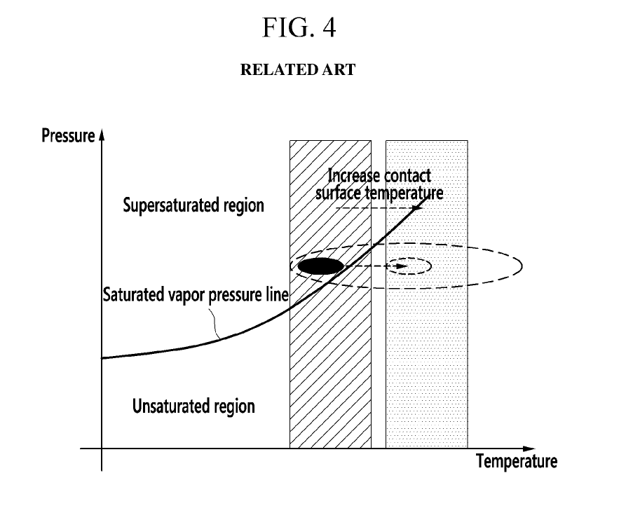

FIG. 3 is a saturated vapor pressure line diagram illustrating a case in which condensation is prevented by suppressing an internal pressure from increasing according to the related. FIG. 4 is a saturated vapor pressure line diagram illustrating a case in which condensation is prevented by increasing a contact surface temperature according to the related art. FIGS. 3 and 4 illustrate methods for generating internal air around parts where the condensation occur in an unsaturated state to prevent the condensation occurring upon the totally enclosed motor operation.

As illustrated in FIG. 3, to suppress an internal pressure from increasing, air permeability between the inside and the outside of the motor needs to be increased. Accordingly, ventilating apertures may be machined in the motor housing or an air permeable material may be attached to a portion of the motor housing. However, a method for machining apertures through which air is suctioned and discharged in a motor housing degrades waterproof performance of the totally enclosed motor and a method for attaching an air permeable material to a motor housing may be difficult to secure enough air permeability to prevent the condensation.

As illustrated in FIG. 4, to increase the contact surface temperature between the internal air and the parts, an additional temperature increasing apparatus is required. In other words, additional power consumption is required to increase the temperatures of an inner surface of the motor housing or surfaces of other parts, which may cause product prices to increase and fuel consumption may be reduced.

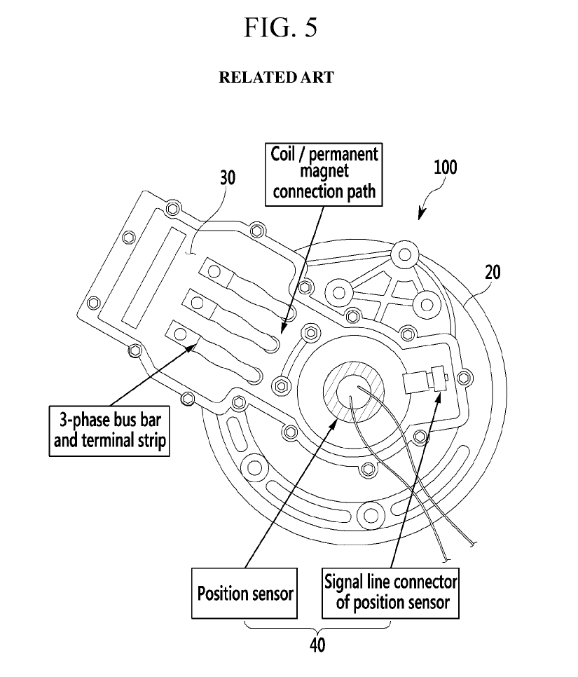

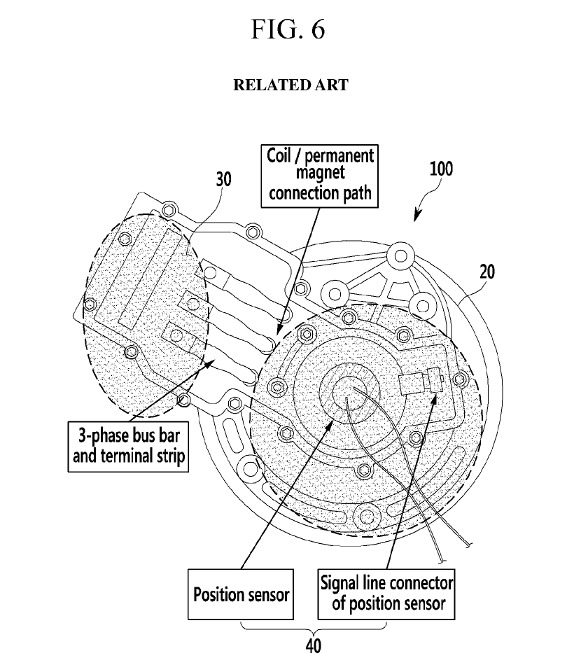

FIG. 5 is a diagram schematically illustrating the internal space before the existing totally enclosed motor is driven according to the related art. FIG. 6 is a diagram schematically illustrating an internal space after the existing totally enclosed motor is driven according to the related art. FIGS. 5 and 6 illustrate an appearance in which a front cover of a totally enclosed motor 100 is separated. Although not illustrated, the totally enclosed motor 100 illustrated in FIGS. 5 and 6 may include a rotor, a stator, a coil wound around at least one of the rotor and the stator, and a permanent magnet installed at at least one of the rotor and the stator.

Generally, depending on the type of motor, a configuration of the elements may vary. An internal space 30 of the motor housing 20 includes the 3-phase bus bar and terminal block and a position sensor unit 40 (e.g., a position sensor) and a space in which the 3-phase bus bar is disposed and a space in which the position sensor unit 40 is disposed communicate with each other. It is apparent to those skilled in the art that an inside of the coil/permanent magnet connection path includes the rotor and the stator.

Referring to FIG. 6, condensation may occur in regions shown by a dotted line after the existing totally enclosed motor is driven. The 3-phase bus bar is supplied with a current upon the driving of the motor and therefore the temperature increases, and the condensation occurs minimally and a minimal amount of condensation occurs at the terminal block side. As a result, the space in which the 3-phas bus bar and terminal block is disposed is a space in which there may be minimal failure risk. However, the space in which the position sensor unit 40 is disposed has a relatively lower temperature change and therefore a relatively greater amount of condensation may occur and a position sensor and a signal line connector of the position sensor may have a failure and malfunction risk due to moisture and therefore the space in which the position sensor unit 40 is disposed has a greater failure risk.

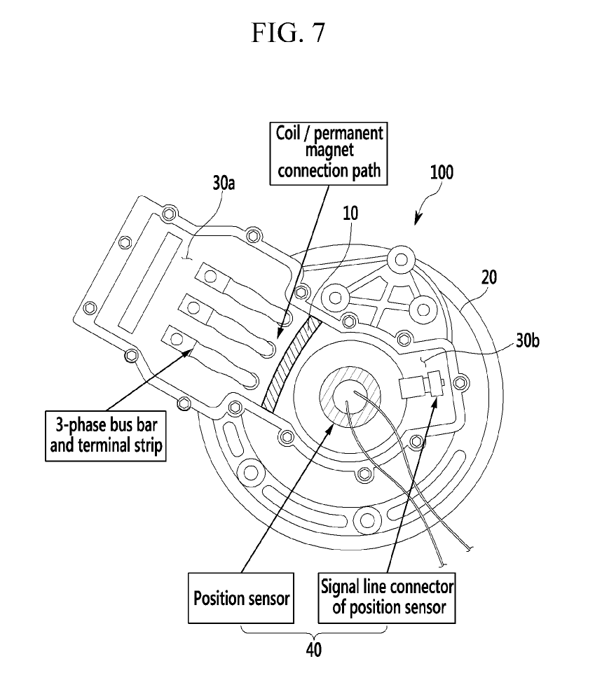

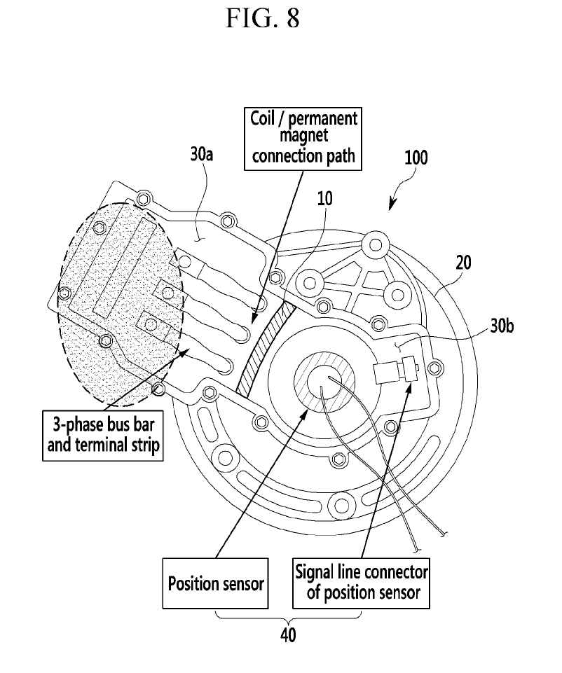

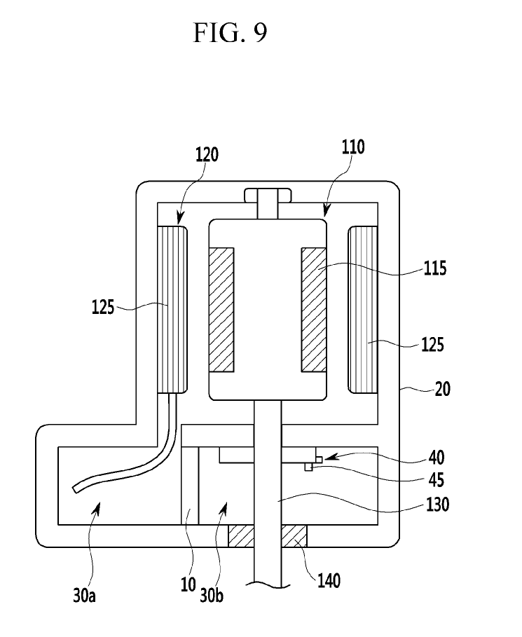

FIG. 7 is a diagram schematically illustrating an inside space before a totally enclosed motor according to an exemplary embodiment of the present invention is driven. FIG. 8 is a diagram schematically illustrating the inside space before the totally enclosed motor according to the exemplary embodiment of the present invention is driven. FIG. 9 is a cross-sectional view of the totally enclosed motor according to the exemplary embodiment of the present invention. Referring to FIGS. 7, 8, and 9, a totally enclosed motor 100 according to an exemplary embodiment of the present invention may include a motor unit having a rotor 110 and a stator 120. The rotor 110 may include a rotor shaft 130 and a permanent magnet 115 fixed on the rotor shaft 130 rotatably mounted at the housing 20 by a bearing 140. The stator 120 may include a coil 125 wound in the stator 120.

Although the coil 125 is shown to be formed at the stator 120, it may be notable that the coil may be formed at the rotor or at both the rotor and the stator. The permanent magnet may also be disposed at the stator or at both of the rotor and stator, depending on the scheme of the motor. It is notable that the present invention is not limited to a specific scheme of the motor unit. The totally enclosed motor 100 may further include an electrical harness such as a 3-phase bus bar, configured to supply electricity to the coil of the motor unit, and a position sensor unit 40 configured to measure an angular position of the rotor 110. The position sensor unit 40 may include a position sensor and a signal line connector configured to transmit the signal of the position sensor to exterior (e.g., to an external component or controller or to another controller within the vehicle). The motor unit, the position sensor unit 40, the 3-phase bus bar may be enclosed in the internal space 30 of the housing 20.

According to the present exemplary embodiment, the housing may be air-tightly separated or split into a first space 30a and a second space 30b, e.g., by a separation bulkhead 10. Thus, air may not communicate between the first and second spaces 30a and 30b (e.g., each space is sealed from the other), and heat transfer by convection may be prevented between the first and second spaces 30a and 30b. Therefore, pressures and temperatures of the first and second spaces 30a and 30b may be maintained differently.

The first space 30a may be configured to enclose the motor unit and the 3-phase bus bar, and the second space 30b may be configured to enclose the position sensor unit 40. The second space 30b may further enclose an electronic component 45, such as an electronic controller, or a signal processor, which is vulnerable to moisture and thus generally has a greater failure risk upon an occurrence of condensation. Since the motor unit configured to generate a substantial amount of heat during operation, the first space 30a may be highly heated during the operation of the totally enclosed motor, thus causing pressure of the first space 30a to increase.

However, since the second space 30b is air-tightly separated from the first space 30a, the temperature and pressure of the second space 30b may not be affected by the increase of temperature and pressure of the first space 30a. Thus, the possibility of forming condensation in the second space 30a may be reduced, thereby protecting the position sensor unit 40 and the electronic component 45 by preventing the components from exposure to water and moisture caused by condensation. Even when condensation occurs in the first space 30a during the operation of the totally enclosed motor, the moisture may be blocked from entering the second space 30b separated from the first space 30a.

It is notable that the bulkhead 10 may be plural and thus, the internal space 30 may be air-tightly separated into three or more spaces. In addition, it is notable that the air-tight separation or splitting of the internal space 30 into the first and second spaces 30a and 30b may also be achieved by other forms, e.g., increasing a size of an element employed in the motor to separate the second space 30b from the first space 30a enclosing the motor unit.

It is known that to prevent the condensation, pressure may be decreased or temperature may be increased. For a totally enclosed motor, a ventilation aperture or an air permeable material may be formed at the housing 20 allowing air to may communicate therethrough to decrease the pressure or the temperature inside the housing. However, according to the present invention, such a ventilation aperture or an air permeable material may be omitted from the housing 20 for the second space 30b, since the condensation may be prevented in the second space 30b by being separated from the first space 30a. Furthermore, an active heating device for increasing temperature of the internal space, e.g., an electrical heater, may be used in the related art to prevent the condensation. However, according to the present exemplary embodiment, such an active heating device may be omitted from the second space 30b, since the condensation may be prevented in the second space 30b by being separated from the first space 30a.

As described above, according to the exemplary embodiment of the present invention, it may be possible to prevent the condensation from occurring in the specific space and the specific part inside the totally enclosed motor and improve the stability and durability of the totally enclosed motor without requiring the additional temperature increasing apparatus and the additional power and increasing the costs.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A enclosed motor, comprising:
a housing that forms a motor space for the motor;
a motor unit having a rotor, a stator, and a rotor shaft; and
a position sensor unit configured to measure an angular position of the rotor,
wherein the motor space is air-tightly split to form a first space that encloses the motor unit and a second space that encloses the position sensor unit.

2. The enclosed motor of claim 1, further comprising:
an electrical harness configured to supply electricity to the motor unit,
wherein the electrical harness is disposed inside the first space.

3. The enclosed motor of claim 1, further comprising:
an electronic component disposed in the second space.

4. The enclosed motor of claim 2, wherein the electrical harness includes a 3-phase bus bar;
and the motor space is air-tightly split by a bulkhead formed between the bus bar and the position sensor unit.

5. The enclosed motor of claim 1, wherein a ventilation aperture is omitted from the housing for the second space.

6. The enclosed motor of claim 1, wherein an air permeable material omitted from the housing for the second space.

7. The enclosed motor of claim 1, wherein an active heating device is omitted from the second space.

8. The enclosed motor of claim 1, wherein the rotor includes a rotor shaft and a permanent magnet fixed on the rotor shaft rotatably mounted at the housing.

9. The enclosed motor of claim 8, wherein the stator includes a coil wound in the stator.

10. The enclosed motor of claim 1, wherein the position sensor unit includes a position sensor and a signal line connector that is configured to transmit the signal of the position sensor to the exterior.
